(19) United States
(12) Patent Application Publication
(10) Pub. No.: US 2021/0331938 A1
(43) Pub. Date: Oct. 28, 2021

(54) Sodium metal oxide material for secondary batteries and method of preparation

(71) Applicant: HALDOR TOPSØE A/S, Kgs. Lyngby (DK)

(72) Inventor: Jon FOLD VON BÜLOW, Copenhagen N (DK)

(73) Assignee: HALDOR TOPSØE A/S, Kgs. Lyngby (DK)

(21) Appl. No.: 17/281,066

(22) PCT Filed: Sep. 25, 2019
(86) PCT No.: PCT/EP2019/075858

§ 371 Date: Mar. 29, 2021

(30) Foreign Application Priority Data
Oct. 5, 2018 (DK) PA2018 00688

(51) Int. Cl. C01G 53/00; H01M 10/36

(52) U.S. Cl. CPC C01G 53/44; H01M 10/36; C01P 2004/80; C01P 2004/61; C01P 2006/12

(57) ABSTRACT

The invention relates to a sodium metal oxide material for an electrode of a secondary battery, where the sodium metal oxide material comprises: NaₓM_{y}Co_{z}O_{2-δ}, where M contains one or more of the following elements: Mn, Cu, Ti, Fe, Mg, Ni, V, Zn, Al, Li, Sn, Sb, 0.7≤x≤1.3, 0.9≤y≤1.1, 0≤z<0.15, 0≤δ<0.2 and wherein the average length of primary particles of said sodium metal oxide material is between 3 and 10 μm, preferably between 5 and 10 μm. The invention also relates to a method for producing the sodium metal oxide material of the invention.

### FIELD OF THE INVENTION

Embodiments of the invention generally relate to a sodium metal oxide material for an electrode of a secondary battery. In particular, embodiments of the invention relate to a material with the composition NaₓM_{y}Co_{z}O_{2-δ}, where M is one or more of the following elements: Mn, Cu, Ti, Fe, Mg, Ni, V, Zn, Al, Li, Sn, Sb, and where 0.7≤x≤1.3, 0.9≤y ≤1.1, 0≤z<0.15, 0≤δ<0.2.

### BACKGROUND

Combustion of fossil fuels leads to a high level of carbon dioxide which is released to the atmosphere. The general consensus is that this pollution is a significant cause of global climate change. This generates an ever increasing demand for replacing conventional fossil fuels with clean energy. The intermittent nature of the clean and renewable energy generation that is employed in our societies today, requires economical and sustainable energy storage. In addition to Li-ion batteries (LIBs) and Lead acid batteries (PbA), Sodium-ion batteries (SIBs) are considered as a promising alternative for gridscale storage applications due to the natural abundance and low cost of sodium resources and the “rocking-chair” sodium storage mechanism that is similar to the one used in lithium-ion batteries.

The search for optimal electrode materials with superior electrochemical performance is currently the key development area of SIBs. Within this research area, layered transition metal oxides represent a class of excellent electrode materials owing in part to their environmental benignity, and facile synthesis. However, the large scale production of Na-ion cathode materials is still in its infancy and a major challenge is still to achieve optimal material powder properties (density, flowability, and stability) in order to advance the SIB technology to be commercially competitive with LIBs and PbA.

### SUMMARY OF THE INVENTION

Embodiments of the invention generally relate to a sodium metal oxide material for an electrode of a secondary battery. It is an object of the invention to provide a sodium metal oxide material having an improved electrochemical stability. It is also an object of the invention to provide a sodium metal oxide material wherein the length of the primary particles is increased compared to known sodium metal oxide materials. It is a further object of the invention to provide a sodium metal oxide material with a high tap density allowing for high loading of sodium metal oxide material within commercial electrodes. It is a further object of the invention to provide a sodium metal oxide material having a favorable or even optimal surface area. It is a further object of the invention to provide a method of preparing the sodium metal oxide material of the invention.

One embodiment of the invention provides a sodium metal oxide material for an electrode of a secondary battery, where the sodium metal oxide material comprises: NaₓM_{y}Co_{z}O_{2-δ}, where M is one or more of the following elements: Mn, Cu, Ti, Fe, Mg, Ni, V, Zn, Al, Li, Sn, Sb, where 0.7≤x≤1.3, 0.9≤y≤1.1, 0≤z<0.15, 0≤δ<0.2 and wherein the average length of primary particles of the sodium metal oxide material is between 3 and 10 μm, preferably between 5 and 10 μm.

When the average length of primary particles of the sodium metal oxide material is between 3 and 10 μm, the structural stability and density of the sodium metal oxide material is improved. Preferably, the average length of the primary particles lies between 5 and 10 μm. The electrochemistry is improved when the average length of the primary particles is increased. Finally, the processing of the sodium metal oxide material to a battery cell is easier when the primary particles are large, in that the sodium metal oxide material is less dusty, packs easier and provides an appropriate loading in an electrode. For instance, x is between 0.8 and 1 in order to provide as high a capacity of the material as possible. The term “length of primary particles” is meant to denote the greatest of three dimensions of an object; therefore, the length of a primary particle is the widest facet or side of the primary particle. In the cases where the primary particles have a clearly widest side or facet, the dimension of such a largest side or facet is the length. Moreover, the length of the primary particle is the diameter, if the primary particle is disc-shaped and circular.

Cobalt (Co) is a common element in layered oxide materials for Li- and Na-ion batteries. However, it is generally desired to reduce the Co content to reduce cost. Therefore, in the material according to the invention, Co is not a main component of the material; however, Co may be present as a dopant or substituent as seen in the commercialized lithium analog LiNi_{0.8}Co_{0.15}Al_{0.05}O₂.

In an embodiment, the average volume of primary particles of the sodium metal oxide material is at least 8 μm³. Thus, in the case where the primary particles have a shape that does not allow for the determination of a diameter or a characteristic length, e.g. in the case where the primary particles appear spherical or dice-shaped, reference is made to the volumetric size of the primary particles in such a way that the average volume is larger than 8 μm³, corresponding to primary particles being larger than dice-shaped particles with the side lengths ×2×2 μm.

The value of δ is the value that provides charge neutrality of the sodium metal oxide material. This value depends upon the oxidation state of the elements of the sodium metal oxide material.

It should also be noted, that indicating that the material is NaₓM_{y}Co_{z}O_{2-δ}, where M is one or more of the following elements: Cu, Ti, Fe, Mg, Ni, V, Zn, Al, Li, Sn, Sb, wherein 0.7≤x≤1.3, 0.9≤y≤1.1, 0≤z<0.15, 0≤δ<0.2, is meant to denote that the combination of elements is represented by “M” and is provided in an amount corresponding to 0.9≤y≤1.1.

Preferred embodiments of the sodium metal oxide material include: Na_{0.78}Ni_{0.2}Fe_{0.38}Mn_{0.42}O₂, Na_{1.00}Ni_{0.25}Fe_{0.5}Mn_{0.25}O₂, and Na_{0.76}Mn_{0.5}Ni_{0.3}Fe_{0.1}Mg_{0.1}O₂.

The expression “the material comprises” is meant to denote that the material may also comprise impurities, but that the material mainly has the indicated stoichiometry.

For the avoidance of doubt, the term “primary particle” is used herein in its conventional meaning, i.e. to refer to the individual fragments of matter in a particulate material. IUPAC defines a “primary particle” as the “smallest discrete identifiable entity” in a particulate material. Such smallest discrete identifiable entities are single crystals. Primary particles may be distinguished from secondary particles, which are particles assembled from a plurality of primary particles and held together either by weak forces of adhesion or cohesion in the case of agglomerates, or by strong atomic or molecular forces in the case of aggregates. The primary particles forming secondary particles retain an individual identity.

In an embodiment, z=0 in the formula NaₓM_{y}Co_{z}O_{2-δ}This corresponds to a cobalt free material, which is advantageous in that cobalt is a scarce and costly element.

In an embodiment, the primary particles have a length and a thickness, where the thickness is smaller than the length, and where the average thickness of primary particles is between 1.0 and 4.0 μm, preferably between 2.0 and 3.5 μm. Typically, the primary particles have a platelet-like morphology with clear facets, where the largest dimension or an equivalent diameter of the primary particles is clearly larger than the thickness of the primary particles. See FIG. 1.

It should be noted that the average length of primary particles is determined per number of particles having a determinable length. Thus, if the length of a given number of particles on a SEM image of the primary particles of a material are determinable, a measure of the average length may be determined based upon those primary particles having a determinable length. Only a fraction of the particles in a SEM image may have a determinable length. Preferably, the determination of the average length is based upon a range of SEM images or similar images of primary particles of the material. Similar considerations apply to the average thickness of primary particles.

Moreover, each of the particles contributing to the determination of the average length and/or average thickness should have a sensible size. Thus, if a particle has a length smaller than 1 nm or larger than 500 μm, such a particle is not to considered a part of the material and is thus not to contribute to the determination of the average length and/or the average thickness.

In an embodiment, M contains Ni and at least one further metal chosen from the group of: Mn, Cu, Ti, Fe, Mg. Preferred embodiments of such a sodium metal oxide material include: Na_{0.78}Ni_{0.2}Fe_{0.38}Mn_{0.42}O₂.

In an embodiment, the sodium metal oxide material contains Ni and Mn. Preferred embodiments of such a sodium metal oxide material include: Na_{1.0}Ni_{0.5}Mn_{0.5}O₂.

In an embodiment, the sodium metal oxide material contains Na as well as the metals Ni, Mn, Ti and Mg. Preferred embodiments of such a sodium metal oxide material include: Na_{0.9}Ni_{0.3}Mn_{0.3}Mg_{0.15}Ti_{0.25}O₂, Na_{0.85}Ni_{0.283}Mn_{0.283}Mg_{0.142}Ti_{0.292}O₂, Na_{0.833}Ni_{0.317}Mn_{0.467}Mg_{0.10}Ti_{0.117}O₂, Na_{0.8}Ni_{0.267}Mn_{0.267}Mg_{0.133}Ti_{0.333}O₂, and Na_{0.75}Ni_{0.25}Mn_{0.25}Mg_{0.125}Ti_{0.375}O₂.

In an embodiment, the sodium metal oxide material is a mixed phase material comprising the P2 and O3 phases. It is believed that the mixed phase material provides an improved electrochemical stability. As used herein, the phase composition of the sodium metal oxide material is in its discharged form after a number of cycles or in its pristine discharged form, viz. in its form as synthesized. In an embodiment, the sodium metal oxide material is a double phase material having 20-40 wt % P2 phase and 60-80 wt % 03 phase as determined by Rietveld refinement of a powder X-ray diffractogram. It is an advantage of the invention that it is possible to provide a mixed phase material with a specific P2/O3 phase ratio. It seems that the P2 phase contributes to power capabilities of the material due to better Na-ion transport properties, while the O3 contributes to the capacity of the material. Within this context, the term “mixed phase material” is meant to denote a material having both phases P2 and O3, where each of these phases is present by at least 5 wt %.

As described in the article of Wang, P. F. et al “Layered Oxide Cathodes for Sodium-Ion Batteries: Phase Transition, Air Stability, and Performance”, Advanced Energy Materials, 2018, 8(8), 1-23, a typical layered structure of NaₓTMO₂ consists of alternately stacking of edge sharing TMO₆ octahedral layers and Na ion layers. Here “TM” means transition metal. These sodium-based layered materials can be categorized into two main groups: P2 type or O3 type according to the surrounding Na⁺ environment and the number of unique oxide layer stacking. This was first specified by Delmas et al. The symbols “P” and “O” represents a prismatic or octahedral coordination environment of Na ions, and the “2” or “3” suggests the number of transition metal layers with different kinds of O stacking in a single cell unit. Schematic illustration of crystal structures of P2 and O3 phases is depicted in FIG. 1 of the above cited article of Wang, P. F. et al.

P2-type NaₓTMO₂ consists of two kinds of TMO₂ layers (AB and BA layers) with all Na+ located at so-called trigonal prismatic (P) sites. Na+ could occupy two different types of trigonal prismatic sites: Na_{f}(Na₁) contacts the two TMO6 octahedra of the adjacent slabs along its face, whereas Naₑ (Na₂) contacts the six surrounding TMO₆ octahedra along its edges. These adjacent Na_{f} and Naₑ sites are too close to be occupied simultaneously because of the large Coulombic repulsion between two adjacent Na ions.

In O3-type NaₓTMO₂, owing to larger ionic radius of Na ions (1.02 Å) compared to 3d transition metal ions with a trivalent state (<0.7 Å), Na⁺ and 3d transition metal ions are accommodated at distinct octahedral sites with a cubic-close-packed (ccp) oxygen array. O3-type layered phases can be classified as one of the cation-ordered rock-salt superstructure oxides. Edge-shared NaO₆ and TMO₆ octahedra order into alternate layers which are perpendicular to [111], forming the NaO₂ and TMO₂ slabs, respectively. As a layered structure, NaTMO₂ is composed of crystallographically three kinds of TMO₂ layers, the so-called AB, CA, and BC layers, with different O stacking (see FIG. 1c of the above cited article of Wang, P. F., et al.) to describe the unit cell, and Na ions are accommodated at the so-called octahedral (O) sites between TMO₂ layers forming a typical O3-type layered structure.

In an embodiment, the tap density of the sodium metal oxide material is between 1.5 and 2.5 g/cm³. For example, the tap density of the sodium metal oxide material is between 1.7 and 2.2 g/cm³.

“Tap density” is the term used to describe the bulk density of a powder (or granular solid) after consolidation/compression prescribed in terms of ‘tapping’ the container of powder a measured number of times, usually from a predetermined height. The method of ‘tapping’ is best described as ‘lifting and dropping’. Tapping in this context is not to be confused with tamping, sideways hitting or vibration. The method of measurement may affect the tap density value and therefore the same method should be used when comparing tap densities of different materials. The tap densities of the present invention are measured by weighing a measuring cylinder before and after addition of at least 10 g of powder to note the mass of added material, then tapping the cylinder on the table for some time and then reading of the volume of the tapped material. Typically, the tapping should continue until further tapping would not provide any further change in volume. As an example only, the tapping may be about 120 or 180 times, carried out during a minute.

The tap density is a property that depends a lot on the particle size distribution; tap densities referred to herein are values measured on powders that have been milled to the following particle size distribution: 3 μm<d(0.1)<7 μm, 7 μm<d(0.5)<14 μm and 14 μm<d(0.9)<25 μm. These tap densities and particle size distributions are appropriate for obtaining a sufficient capacity and an appropriate porosity of the sodium metal oxide material. The entire particle size distribution within a material, i.e. the volume fraction of particles with a certain size as a function of the particle size, is a way to quantify the size of particles in a suspension or a powder. In such a distribution, d(0.1) or D10 is defined as the particle size where 10% of the population lies below the value of d(0.1) or D10, d(0.5) or D50 is defined as the particle size where 50% of the population lies below the value of d(0.5) or D50 (i.e. the median), and d(0.9) or D90 is defined as the particle size where 90% of the population lies below the value of d(0.9) or D90. Commonly used methods for determining particle size distributions include dynamic light scattering measurements and scanning electron microscopy measurements, coupled with image analysis.

In an embodiment, the BET area is between 0.3 and 1 m²/g. Preferably, the BET area is between 0.3 and 0.6 m²/g. It is well-known that a low BET area is related to low degradation of the material when cycled in an electrochemical cell.

In an embodiment, the sodium metal oxide material has been manufactured by mixing of precursor materials in a dispersion, drying and heating in an oven. This is in contrast to precipitation of a sodium metal oxide material. It is well-known that precipitated sodium metal oxide materials may obtain tap densities up to about 2 g/cm³. However, mixing and drying materials typically provide materials with lower tap densities than that obtained by the invention. The dispersion is e.g. an aqueous dispersion and the drying method is e.g. spray drying.

As used herein, the term “oven” is meant to denote any appropriate vessel for heating to well above 500° C., such as a kiln or a furnace. Another aspect of the invention provides a method of preparing a sodium metal oxide material comprising NaₓM_{y}Co_{z}O_{2-δ}, where M is one or more of the following elements: Mn, Cu, Ti, Fe, Mg, Ni, V, Zn, Al, Li, Sn, Sb, where 0.7≤x≤1.3, 0.9≤y≤1.1, 0≤z<0.15, 0≤δ<0.2 and wherein the average length of primary particles of the sodium metal oxide material is between 3 and 10 μm. The method comprises the steps of:

a) Mixing precursor materials comprising sodium salt and a salt or oxide of at least one of the following elements: Mn, Cu, Ti, Fe, Mg, Ni, V, Zn, Al, Li, Sn, Sb, in a dispersion to a mixed precursor, wherein the mixed precursor comprises carbonate;

b) Drying the mixed precursor to a mixed precursor having a moisture content between 2 and 15 wt %;

c) Placing the mixed precursor in an oven and heating the oven to a temperature of between 800 and 1000° C. to provide the sodium metal oxide material; and

d) Cooling the sodium metal oxide material to room temperature in an atmosphere with less than 100 ppm CO₂.

The salt(s) of the precursor materials can be any appropriate salt(s). One example is to use oxides or carbonates, such as sodium carbonate and carbonates of Ni and/or one of: Mn, Cu, Ti, Fe, and Mg. Alternatively, sodium nitrate or sodium hydroxide could be used. Typically, sulfates would not be used due to the sulfur that would remain in the material after preparation, nitrates would not be used in order to avoid NOx emissions during the heat treatment and chlorides would also rarely be used.

Step d) takes place in an atmosphere with less than 100 ppm CO₂ and preferably below 50 ppm CO₂. Whilst step d) is carried out in a CO₂ poor atmosphere, steps a) to c) are e.g. carried out in air or in an atmosphere resembling air, such as between 75 and 85% nitrogen, between 15 and 25 oxygen, possibly some argon and possibly some CO₂.

According to an embodiment of the method according to the invention the heating of step c) comprises the steps of:

c1) heating the oven to a first temperature T1 between 900 and 1000° C.;

c2) maintaining the temperature of the oven at the first temperature T1 until a specific phase distribution between P2 and O3 phases is achieved;

c3) cooling the oven to a second temperature T2, where T2 is between 800 and 950° C. and wherein T2 is 50-150° C. lower than T1; and

c4) maintaining the temperature of the oven at the second temperature T2 until the sodium metal oxide material is substantially carbonate free.

It is an advantage of the method of the invention that it is possible to provide a mixed phase material with a specific P2/O3 phase ratio. Step c2) ensures that the primary particles sinter and grow to a size wherein the average length of the primary particles of the sodium metal oxide material is between 3 and 10 μm, preferably even between 5 and 10 μm. The specific phase distribution between P2 and O3 phases in step c2) is somewhat different from the final phase distribution of the sodium metal oxide material. Typically, the specific phase distribution has somewhat less O3 than the final phase distribution of the sodium metal oxide material. Step c4) ensures that the phase distribution is changed so that somewhat more O3 is present in the final material than in the material between steps c2) and c3). Typically, the material would have 5-20 wt % more O3 in the final material than in the material between steps c2) and c3). Thus, step c3) changes the phase distribution towards more O3, but only to an extent of 5-20 wt %. Thus, the final phase distribution of the sodium metal oxide material is still a phase distribution with both P2 and O3 phases, each in a percentage of at least 20 wt %.

The term “the sodium metal oxide material is substantially carbonate free” is meant to denote that the sodium metal oxide material in equilibrium with air at step c4) forms an atmosphere that contains less than about 2000 ppm carbonate. Atmospheric air has about 400 ppm CO₂, but during steps c1) and c2) substantial amounts of CO₂, such as up to 20 vol %, can be detected within the oven. Step c4) is continued until the CO₂ level is less than 5000 ppm, e.g. 2000 ppm CO₂. The CO₂ level may e.g. be measured by a Carbondio 2000 gas module sensor (0-2000 ppm CO₂) from Pewatron AG. This CO₂ level corresponds to a Na₂CO₃ content in the sodium metal oxide material of maximum 0.5 wt % Na₂CO₃ as measured with thermal gravimetric analysis (TGA) using a Netzsch STA 409C that meets respective instrument and applications standards, including ISO 11358, ISO/DIS 9924, ASTM E1131, ASTM D3850, DIN 51006.

Typically, step c4) corresponds to maintaining the temperature of the oven until substantially all sodium carbonate is decomposed. As an example, step c4) corresponds to maintaining the temperature of the oven at the temperature T2 between 5 and 20 hours, for example 8-10 hours. The term “maintaining the temperature” is meant to denote that the temperature remains relatively stable. However, smaller temperature changes of e.g. 10-20° C. are meant to be covered by the term “maintaining the temperature”. The term “cooling the oven” is meant to cover both the instance that the material is maintained in one oven, the temperature of which is lowered, and the instance that the material is transported within an oven, from one hotter part to another, cooler part, e.g. on a conveyor belt.

By the method of the invention, a mixed phase material having good slurry properties as well as good power properties is obtainable.

According to another aspect of the invention, the invention relates to a sodium metal oxide material for an electrode of a secondary battery, said sodium metal oxide material comprising: NaₓM_{y}Co_{z}O_{2-δ}, where M is one or more of the following elements: Mn, Cu, Ti, Fe, Mg, Ni, V, Zn, Al, Li, Sn, Sb, and where 0.7≤x≤1.3, 0.9≤y≤1.1, 0≤z<0.15, 0≤δ<0.2, and wherein the average volume of primary particles of the sodium metal oxide material is at least 8 μm³. Thus, in the case where the primary particles have a shape that does not allow for the determination of a diameter or a characteristic length, e.g. in the case where the primary particles appear spherical or dice-shaped, reference is made to the volumetric size of the primary particles in such a way that the average volume is larger than 8 μm³, corresponding to being larger than dices having side lengths 2×2×2 μm.

### SHORT DESCRIPTION OF THE FIGURE

FIG. 1 is a schematic drawing of a P2 type material with flake like primary particles.

### DETAILED DESCRIPTION OF THE FIGURE

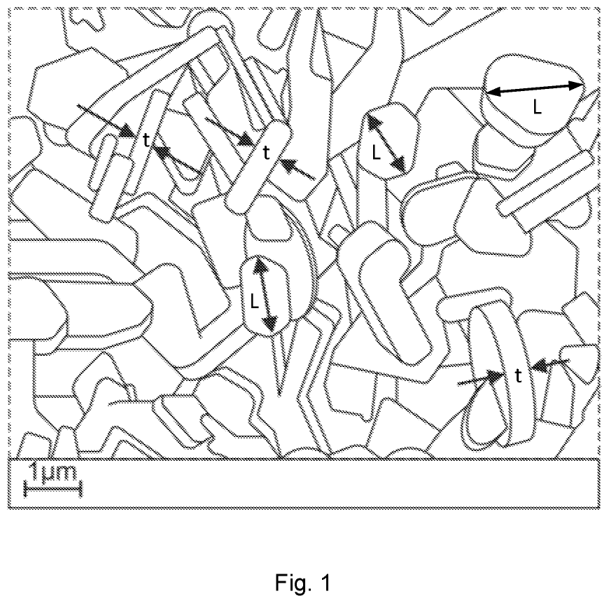

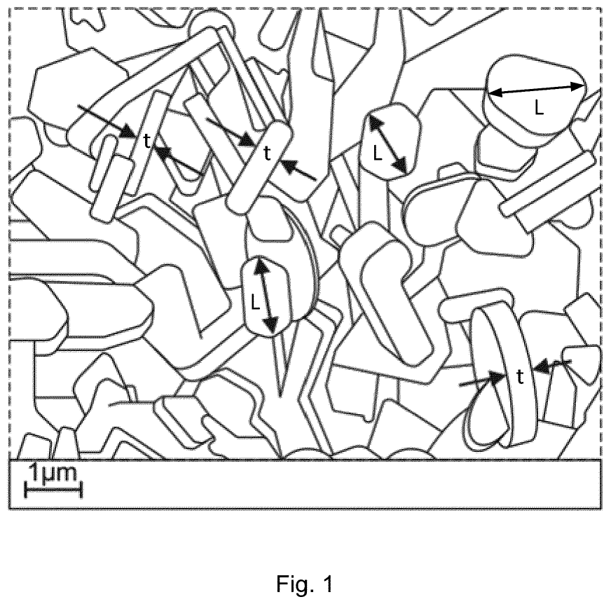

FIG. 1 is a schematic drawing of a P2 type material with flake like primary particles, such as the P2 type material Na_{2/3}Mn_{0.7}Fe_{0.1}Mg_{0.1}O₂. It is seen from FIG. 1, that the primary particles typically have a platelet-like morphology with clear facets, where the largest dimension or an equivalent diameter of the primary particles is clearly larger than the thickness of the primary particles. For a few of the primary particles, the length L or the thickness T has been indicated in FIG. 1. The primary particles are about 1-3 μm in diameter or length and 100-500 nm in thickness. FIG. 1 illustrates that particles have a largest dimension, the length, and a smallest dimension, the thickness. FIG. 1 also illustrates that for some particles, the length or the thickness may not be discernible. In this case only the thickness or the length of the particle is included in a determination of the average length and thickness of the particles in the sample.

The length L of a primary particle is thus the greatest of three dimensions of the primary particle and the thickness of the primary particle is the smallest of the three dimensions thereof.

### EXAMPLE

Preparation of sodium metal ion material:

Precursor materials in the form of a physical mixture of raw material comprising carbonates of Na and Ni and at least one of the elements Mn, Cu, Ti, Fe, and Mg, are mixed in an aqueous dispersion and subsequently spray dried to a powder. The spray dried and mixed precursor material is placed in a sagger. The bulk density of the spray dried and mixed precursor material is about 0.7-1.0 g/cm³ and the sagger is filled so that the bed height of spray dried and mixed precursor material is higher than 35 mm. The mixed and spray dried precursor materials have a moisture content between 2 and 15 wt %. The naggers with 20-22 kg of mixed and spray dried precursor materials containing in total about 0.4-3.3 L of water are loaded into an oven. The oven used in this case is an electrically heated chamber furnace with five-sided heating from Nabertherm (LH 216 with controller C 440) modified with controllable gas inlets.

Subsequently, a heat treatment program of the oven is started and the oven is heated up to oven top temperature of 500° C. with a ramp of 1-5° C./min without any gas flow through the oven. At these conditions, moisture can be observed condensing on the outside of the oven walls because it is not completely gas tight. When the temperature in the top of the oven reaches about 500° C., the powder reaches 280C-320C and the carbonates start decomposing in the saturated moisture atmosphere. At this point, a flow of air of between 20 and 100 L/min is started from the bottom of the oven to the top and it is gradually heated to 900-1000° C. with a ramp of between 1-5° C./min.

After several hours, such as between 5 and 20 hours, the oven is cooled in a flow of CO₂-free air of 1-100 L/min. When the oven has been cooled to about 500° C., nitrogen can be used as cooling medium until the oven reaches room temperature if a higher flow of nitrogen is available.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

1. A sodium metal oxide material for an electrode of a secondary battery, said sodium metal oxide material comprising: NaₓM_{y}Co_{z}O_{2-δ}, where M is one or more of the following elements: Mn, Cu, Ti, Fe, Mg, Ni, V, Zn, Al, Li, Sn, Sb, and where 0.7≤x≤1.3, 0.9<y≤1.1, 0≤z<0.15, 0≤δ<0.2 and wherein the average length of primary particles of said sodium metal oxide material is between 3 and 10 μm.

2. A sodium metal oxide material according to claim 1, wherein z=0.

3. A sodium metal oxide material according to claim 1, wherein the primary particles have a length and a thickness, where the thickness is smaller than the length, and where the average thickness of primary particles is between 1.0 and 4.0 μm.

4. A sodium metal oxide material according to claim 1, wherein M contains Ni and at least one further metal chosen from the group of: Mn, Cu, Ti, Fe, Mg.

5. A sodium metal oxide material according to claim 1, wherein M contains Ni and Mn.

6. A sodium metal oxide material according to any of the claim 1, wherein M contains Ni, Mn, Mg and Ti.

7. A sodium metal oxide material according to claim 1, wherein the sodium metal oxide material is a mixed phase material comprising the P2 and O3 phases.

8. A sodium metal oxide material according to claim 7, wherein the sodium metal oxide material comprises 20-40 wt % P2 phase and 60-80 wt % O3 phase.

9. A sodium metal oxide material according to claim 1, wherein the tap density of said sodium metal oxide material is between 1.5 and 2.5 g/cm³.

10. A sodium metal oxide material according to claim 9, wherein the tap density of said sodium metal oxide material is between 1.7 and 2.2 g/cm³.

11. A sodium metal oxide material according to claim 1, wherein the BET area is between 0.3 and 1 m²/g.

12. A sodium metal oxide material according to claim 1, wherein the sodium metal oxide material has been manufactured by mixing of precursor materials in a dispersion, drying and heating in an oven.

13. A method of preparing a sodium metal oxide material comprising: NaₓM_{y}Co_{z}O_{2-δ}, where M is one or more of the following elements: Mn, Cu, Ti, Fe, Mg, Ni, V, Zn, Al, Li, Sn, Sb, 0.7≤x≤1.3, 0.9≤y≤1.1, 0≤z<0.15, 0 δ<0.2 and wherein the average length of primary particles of said sodium metal oxide material is between 3 and 10 μm, said method comprising the steps of:
a) mixing precursor materials comprising sodium salt and a salt or oxide of at least one of the following elements: Mn, Cu, Ti, Fe, Mg, Ni, V, Zn, Al, Li, Sn, Sb, in a dispersion to a mixed precursor, wherein the mixed precursor comprises carbonate;
b) drying the mixed precursor to a mixed precursor having a moisture content between 2 and 15 wt %;
c) placing the mixed precursor in an oven and heating the oven to a temperature of up to a temperature of between 800 and 1000° C. to provide the sodium metal oxide material; and
d) cooling the sodium metal oxide material to room temperature in an atmosphere with less than 100 ppm CO₂.

14. A method according to claim 13, wherein the heating of step c) comprises the steps of:
c1) heating the oven to a first temperature T1 between 900 and 1000° C.;
c2) maintaining the temperature of the oven at the first temperature T1 until a specific phase distribution between P2 and O3 phases is achieved;
c3) cooling the oven to a second temperature T2, where T2 is between 800 and 950° C. and wherein T2 is 50-150° C. lower than T1;
c4) maintaining the temperature of the oven at the second temperature T2 until the sodium metal oxide material is substantially carbonate free.

15. A sodium metal oxide material for an electrode of a secondary battery, said sodium metal oxide material comprising: NaₓM_{y}Co_{z}O_{2-δ}, where M is one or more of the following elements: Mn, Cu, Ti, Fe, Mg, Ni, V, Zn, Al, Li, Sn, Sb, and where 0.7≤x≤1.3, 0.9≤y≤1.1, 0≤z<0.15, 0 δ<0.2, and wherein the average volume of primary particles of said sodium metal oxide material is at least 8 μm³.
